(19) United States
(12) Patent Application Publication
(10) Pub. No.: US 2016/0184672 A1
(43) Pub. Date: Jun. 30, 2016

(54) GRIP WITH DOUBLE-LAYER ADHESIVE BOUND STRUCTURE

(71) Applicant: HIGH CEDAR ENTERPRISE CO., LTD., Taichung (TW)

(72) Inventor: Yung-Han WANG, Taichung City (TW)

(21) Appl. No.: 14/722,611

(22) Filed: May 27, 2015

(30) Foreign Application Priority Data
Dec. 31, 2014 (TW) 103223395

(51) Int. Cl. A63B 53/14; B32B 7/12; B32B 1/08

(52) U.S. Cl. CPC A63B 53/14; B32B 1/08; B32B 7/12; B32B 2307/56

(57) ABSTRACT

A grip includes an outer sleeve peripherally covering a major-axially directed outer peripheral wall of an inner sleeve, and a combining portion provided between the two sleeves for firmly binding the two sleeves, wherein the combining portion comprises a first adhesive layer and a second adhesive layer. The first adhesive layer is made of hot glue and firmly adheres to a felt layer at an inner peripheral wall of the outer sleeve through heat pressing or thermal reaction. The second adhesive layer adheres to the outer peripheral wall of the inner sleeve with the assistance of pressing or adherence. Hence, there is no need to use any additional jigs or techniques and the sleeves of the grip can be assembled by only the simple steps of mounting, binding or adherence and manufacturing of grips is significantly improves in convenience, practicability and cost.

### BACKGROUND OF THE INVENTION

1. Technical Field

The present invention relates to grips, and more particularly to a grip having sleeves combined as a double-layer adhesive bound structure.

2. Description of Related Art

Grips are usually covered by sleeves or tapes for providing additional shock absorption, friction or sweat absorption. Various types of glue or adhesive have been used to fix such sleeves or tapes onto grips and to bind such sleeves together. As shown in FIG. 1, a grip sleeve 1 includes an outer sleeve piece 10. The outer sleeve piece 10 major-axially and peripherally covers an inner sleeve piece 20. The inner sleeve piece 20 has one end jutting out the outer sleeve piece 10 and folded toward the outer peripheral wall of the outer sleeve piece 10 to form a shield 21. Therein, when the outer sleeve piece 10 peripherally covers the major-axial peripheral wall of the inner sleeve piece 20, adhesive or glue is applied to bind the sleeve pieces 10, 20 firmly for preventing the two from separating.

In practical manufacturing process, the adhesive or glue first adheres to the major-axially directed outer peripheral wall of the outer sleeve piece 10 of the grip sleeve 1 with its one adhesive surface, and then has the release paper or protective film covering it's the other adhesive surface removed, so as to expose its second adhesive surface. Then the inner sleeve piece 20 is major-axially mounted around the outer sleeve piece 10, with its one end jutting out the outer sleeve piece 10. At last, external force is applied to the peripheral wall of the outer sleeve piece 10 to make the two sleeve pieces 10, 20 come close and adhere to each other. However, after the process of removing the release paper or protective film to expose the second adhesive surface of the outer sleeve piece 10 of the grip sleeve 1 an additional jig or technique has to be implemented to help mounting, binding or adherence the sleeve pieces 10, 20, making the subsequent processing demanding and troublesome.

Hence, there is a need for a grip that is easy to produce and eliminates the shortcomings of the prior art.

### SUMMARY OF THE INVENTION

In view of the need as mentioned above, the objective of the present invention is to provide a grip with a double-layer adhesive bound structure, which eliminates the need of using additional jig or techniques to help mounting, binding or adherence sleeves to the grip, thereby making manufacturing of the grip more convenient.

For achieving the foregoing objective, the present invention provides a grip comprising an outer sleeve peripherally covering a major-axially directed outer peripheral wall of an inner sleeve, and a combining portion provided between the two sleeves for firmly binding the two sleeves, wherein the combining portion comprises a first adhesive layer and a second adhesive layer, the first adhesive layer being made of hot glue and adhering to a felt layer at an inner peripheral wall of the outer sleeve, and the second adhesive layer adhering to the outer peripheral wall of the inner sleeve.

Therein, the first adhesive layer of the combining portion is made of EVA-based hot glue, polyamide-made hot glue, TPR-based hot-melt pressure-sensitive adhesive, polyolefin-based hot glue, or PUR hot glue.

Therein, the second adhesive layer of the combining portion is made of solvent-based adhesive tape, emulsion adhesive tape, hot-melt adhesive tape, calendered adhesive tape or reactive adhesive tape.

To sum up, the present invention features that the first adhesive layer of the combining portion can be firmly bound with the inner peripheral wall of the outer sleeve by means of heat pressing or thermal reaction and the second adhesive layer of the combining portion, with the assistance of processes such as pressing or adherence, can be combined with the outer peripheral wall of the inner sleeve with enhanced closeness and firmness. Hence, there is no need to use any additional jigs or techniques and the two sleeves of the grip can be assembled by only the simple steps of mounting, binding or adherence. In this way, the present invention significantly improves manufacturing of grips in convenience, practicability and cost, thereby achieving the expected effects and objectives as stated above.

The disclosed grip with the double-layer adhesive bound structure as well as its effects will be described in detail in the following paragraphs.

### BRIEF DESCRIPTION OF THE DRAWINGS

FIG. 1 is a cross-sectional view of a conventional structure.

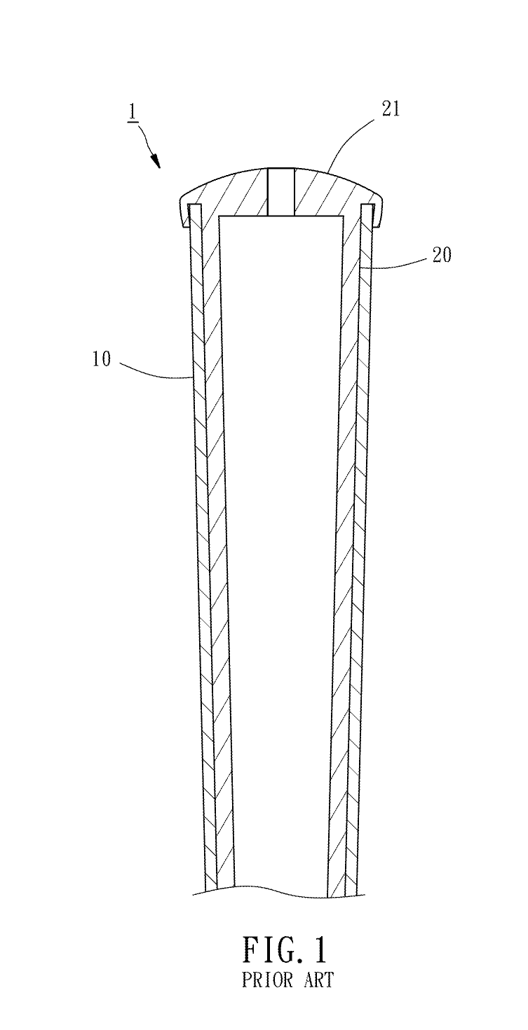

FIG. 2 is a perspective view of one preferred embodiment of the present invention.

FIG. 3 is a cross-sectional view taken along Line 3-3 of FIG. 2.

FIG. 4 is a cross-sectional view of another preferred embodiment of the present invention.

FIG. 5 is a cross-sectional view of still another preferred embodiment of the present invention.

### DETAILED DESCRIPTION OF THE INVENTION

The following preferred embodiments when read with the accompanying drawings are made to clearly exhibit the above-mentioned and other technical contents, features and effects of the present invention. Through the exposition by means of the specific embodiments, people would further understand the technical means and effects the present invention adopts to achieve the above-indicated objectives. However, the accompanying drawings are intended for reference and illustration, but not to limit the present invention and are not made to scale. Unless otherwise noted, like elements will be identified by identical numbers throughout all figures.

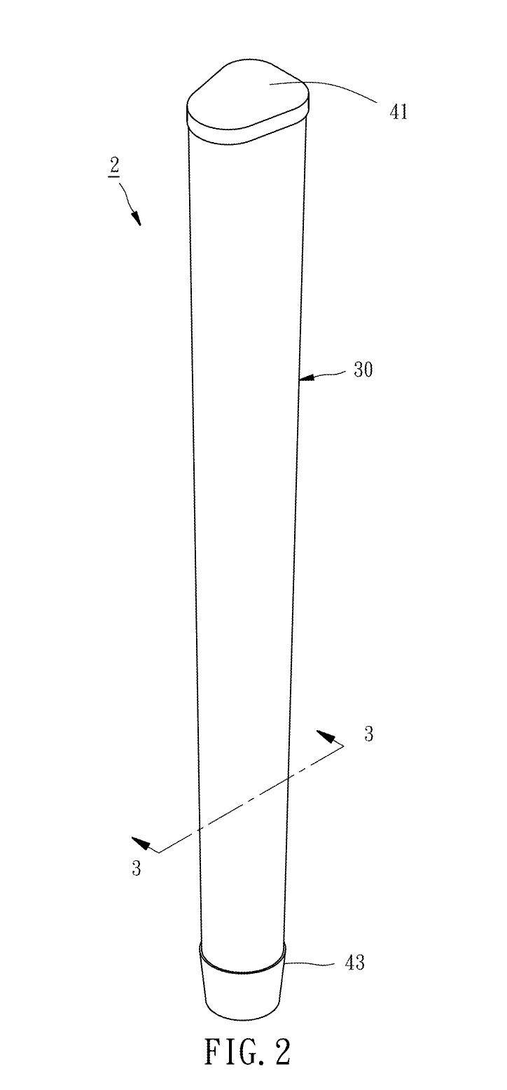

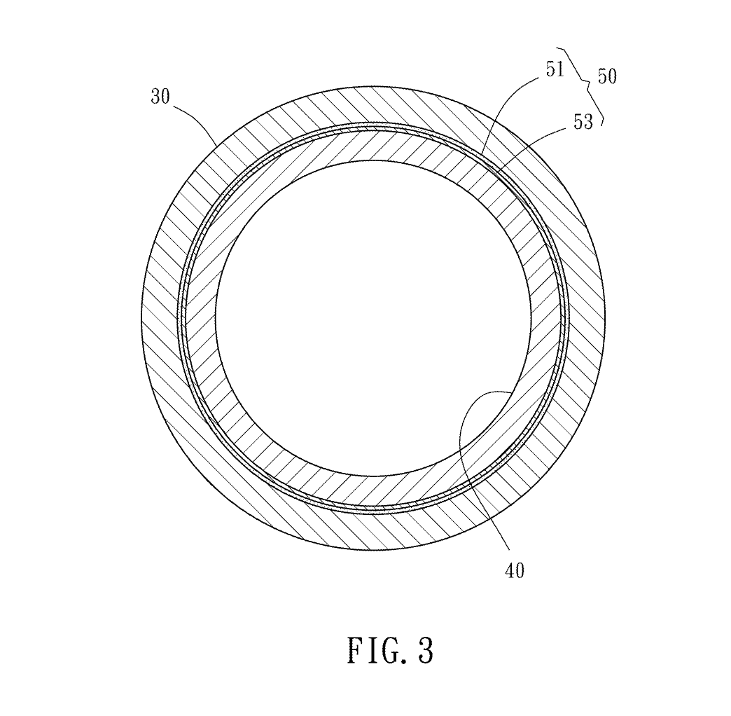

Referring to FIG. 2 and FIG. 3, according to a preferred embodiment of the present invention, a grip 2 comprises:

an outer sleeve 30, an inner sleeve 40 and a combining portion 50.

The outer sleeve 30 peripherally covers a major-axially directed outer peripheral wall of the inner sleeve 40, and the combining portion 50 is provided between the two sleeves 30, 40 for firmly binding them. The inner sleeve 40 has its two ends each provided with an end portion jutting out two ends of the outer sleeve 30 and folded toward the outer peripheral wall of the outer sleeve 30 to form a first cover 41 and a second cover 43, respectively, so as to prevent the outer sleeve 30 and the inner sleeve 40 of the grip 2 departing from each other.

Therein, a first adhesive layer 51 of the combining portion 50 peripherally covers and adheres to the inner peripheral wall of the outer sleeve 30. The inner peripheral wall of the outer sleeve 30 is made of, for example, a felt layer without limitation. The first adhesive layer 51 of the combining portion 50 is made of, for example, ethylene-vinyl-acetate-based hot glue (hereinafter referred to as EVA-based hot glue), polyamide-made hot glue, thermoplastic-rubber-based hot-melt pressure-sensitive adhesive (hereinafter referred to as TPR-based hot-melt pressure-sensitive adhesive), polyolefin-based hot glue, or polyurethane-reactive hot glue (hereinafter referred to as PUR hot glue), without limitation.

Therein, a second adhesive layer 53 of the combining portion 50 peripherally covers and adheres to the outer peripheral wall of the inner sleeve 40. The second adhesive layer 53 of the combining portion 50 is made of, for example, solvent-based adhesive tape, emulsion adhesive tape, hot-melt adhesive tape, calendered adhesive tape or reactive adhesive tape, without limitation.

Therein, the adhesive layers 51, 53 of the combining portion 50 may have their corresponding sides bound, combined or glued with each other.

With the foregoing configuration, the disclosed grip 2 features that the combining portion 50 is adhesively provided between the corresponding sides of the two sleeves 30, 40 of the grip 2 to ensure the close and firm combination between the two sleeves 30, 40. Therein, the first adhesive layer 51 of the combining portion 50 comprises hot glue that can be firmly bound with the felt layer at the inner peripheral wall of the outer sleeve 30 by means of heat pressing or thermal reaction. Further, since the second adhesive layer 53 of the combining portion 50 is itself adhesive, with the assistance of processes such as pressing or adherence, it can be combined with the outer peripheral wall of the inner sleeve 40 with enhanced closeness and firmness. Hence, there is no need to use any additional jigs or techniques and the two sleeves 30, 40 of the grip 2 can be assembled by only the simple steps of mounting, binding or adherence. In this way, the present invention significantly improves manufacturing of grips in convenience, practicability and cost, thereby achieving the expected effects and objectives as stated above.

With the previous description, the configuration, expected effects and objectives of the first preferred embodiment of the present invention have been clear. Hereinafter, another preferred embodiment of the present invention will be discussed.

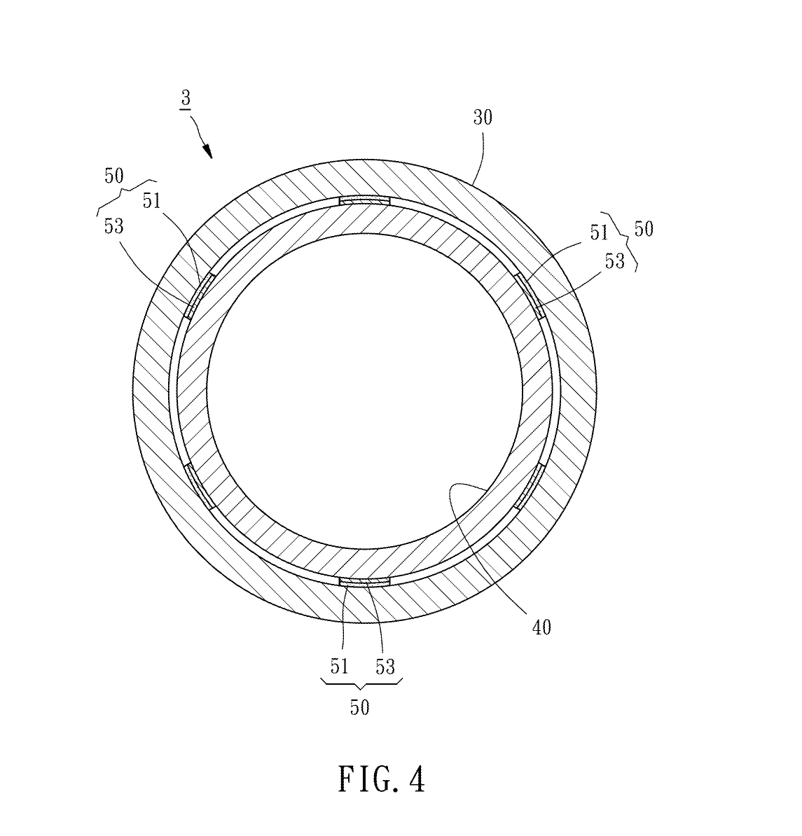

Now referring to FIG. 4, in a second preferred embodiment of the present invention, a grip 3 is similar to that of the previous embodiment except for the following differences.

Any two said combining portions 50 are adhesively provided between the corresponding sides of two said sleeves 30, 40 of the grip 3, and extend major-axially from the same ends of the two sleeves 30, 40 to their opposite ends. As shown in the depicted preferred embodiment of the present invention another, there are six said combining portions 50 separated by a predetermined interval adhesively provided between the corresponding sides of the two sleeves 30, 40 of the grip 3 extending major-axially from the same ends of the two sleeves 30, 40 to their opposite ends along their long axes.

Similarly, the first adhesive layer 51 of each of the combining portions 50 comprises hot glue that can be firmly bound with the felt layer at the inner peripheral wall of the outer sleeve 30 by means of heat pressing or thermal reaction. Further, since the second adhesive layer 53 of the combining portion 50 is itself adhesive, with the assistance of processes such as pressing or adherence, it can be combined with the outer peripheral wall of the inner sleeve 40 with enhanced closeness and firmness.

To sum up, the disclosed grip 3 features that it is applicable to various grips of different sizes available on the market, such as golf club grips, fishing rod handles, tennis racquet grips and badminton racquet grips). With the combining portions 50 that are arranged adjacent and extending major-axially at the corresponding sides on the two sleeves 30, 40, glue or material overflow can be effectively reduced when the first and second adhesive layers 51, 53 of each of the combining portions 50 are bound to the two sleeves 30, 40, thereby significantly reducing material waste for making the grip 3. In this way, the present invention significantly improves manufacturing of grips in convenience, practicability and cost, thereby achieving the expected effects and objectives as stated above.

With the previous description, the configuration, expected effects and objectives of the first preferred embodiment of the present invention have been clear. Hereinafter, still another preferred embodiment of the present invention will be discussed.

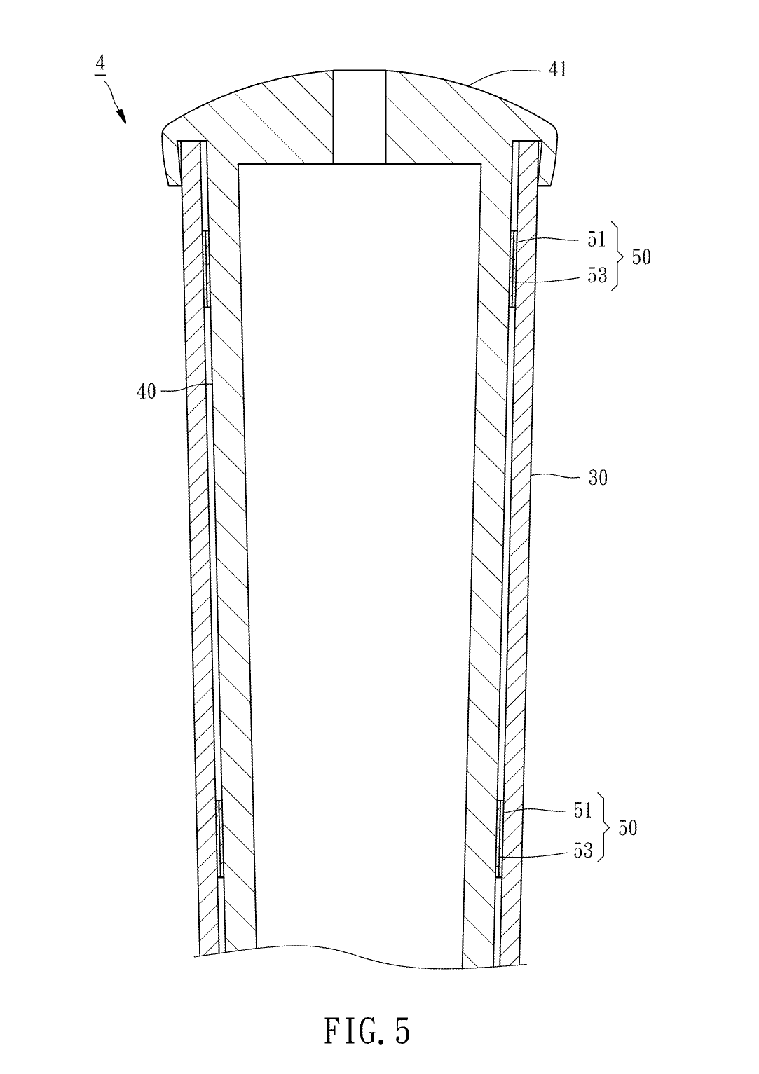

Now referring to FIG. 5, in a third preferred embodiment of the present invention, a grip 4 is similar to that of the previous embodiment except for the following differences.

Any two said combining portions 50 are peripherally and adhesively provided between the corresponding sides of two said sleeves 30, 40 of the grip 4, and the two combining portions 50 are separated on the lengthwise cross sections of the two sleeves 30, 40. In the third embodiment of the present invention, the two combining portions 50 are adhesively provided between the corresponding sides of two said sleeves 30, 40 of the grip 4 from the corresponding ends of the lengthwise cross sections of two said sleeves 30, 40 of the grip 4 to their opposite ends and separately adjacent to each other with a predetermined interval therebetween.

Similarly, first adhesive layer 51 of each of the combining portions 50 comprises hot glue that can be firmly bound with the felt layer at the inner peripheral wall of the outer sleeve 30 by means of heat pressing or thermal reaction. Further, since the second adhesive layer 53 of the combining portion 50 is itself adhesive, with the assistance of processes such as pressing or adherence, it can be combined with the outer peripheral wall of the inner sleeve 40 with enhanced closeness and firmness.

To sum up, the disclosed grip 4 is as effective as the previously described embodiments. Also, glue or material overflow can be effectively reduced when the first and second adhesive layers 51, 53 of each of the combining portions 50 are bound to the two sleeves 30, 40. In this way, the present invention significantly improves manufacturing of grips in convenience, practicability and cost, thereby achieving the expected effects and objectives as stated above.

The present invention has been described with reference to the preferred embodiments and it is understood that the embodiments are not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A grip, comprising:
an outer sleeve peripherally covering a major-axially directed outer peripheral wall of an inner sleeve, and a combining portion provided between the two sleeves for firmly binding the two sleeves, wherein the combining portion comprises a first adhesive layer and a second adhesive layer, the first adhesive layer being made of hot glue and adhering to a felt layer at an inner peripheral wall of the outer sleeve, and the second adhesive layer adhering to the outer peripheral wall of the inner sleeve.

2. The grip of claim 1, wherein the first adhesive layer of the combining portion is made of EVA-based hot glue, polyamide-made hot glue, TPR-based hot-melt pressure-sensitive adhesive, polyolefin-based hot glue, or PUR hot glue.

3. The grip of claim 2, wherein the second adhesive layer of the combining portion is made of solvent-based adhesive tape, emulsion adhesive tape, hot-melt adhesive tape, calendered adhesive tape or reactive adhesive tape.

4. The grip of claim 1, wherein the second adhesive layer of the combining portion is made of solvent-based adhesive tape, emulsion adhesive tape, hot-melt adhesive tape, calendered adhesive tape or reactive adhesive tape.

5. The grip of claim 1, wherein any two said combining portions are adhesively provided between corresponding sides of the two sleeves and major-axially extend abreast from corresponding ends to opposite corresponding ends of the two sleeves.

6. The grip of claim 5, wherein the combining portions are separately adjacent on lengthwise cross sections of the two sleeves.

7. The grip of claim 2, wherein any two said combining portions are adhesively provided between corresponding sides of the two sleeves and major-axially extend abreast from corresponding ends to opposite corresponding ends of the two sleeves.

8. The grip of claim 7, wherein the combining portions are separately adjacent on lengthwise cross sections of the two sleeves.

9. The grip of claim 3, wherein any two said combining portions are adhesively provided between corresponding sides of the two sleeves and major-axially extend abreast from corresponding ends to opposite corresponding ends of the two sleeves.

10. The grip of claim 9, wherein the combining portions are separately adjacent on lengthwise cross sections of the two sleeves.

11. The grip of claim 4, wherein any two said combining portions are adhesively provided between corresponding sides of the two sleeves and major-axially extend abreast from corresponding ends to opposite corresponding ends of the two sleeves.

12. The grip of claim 11, wherein the combining portions are separately adjacent on lengthwise cross sections of the two sleeves.

13. The grip of claim 1, wherein any two said combining portions are peripherally, adhesively provided between corresponding sides of the two sleeves and separately adjacent on lengthwise cross sections of the two sleeves.

14. The grip of claim 2, wherein any two said combining portions are peripherally, adhesively provided between corresponding sides of the two sleeves and separately adjacent on lengthwise cross sections of the two sleeves.

15. The grip of claim 3, wherein any two said combining portions are peripherally, adhesively provided between corresponding sides of the two sleeves and separately adjacent on lengthwise cross sections of the two sleeves.

16. The grip of claim 4, wherein any two said combining portions are peripherally, adhesively provided between corresponding sides of the two sleeves and separately adjacent on lengthwise cross sections of the two sleeves.
